(19) United States
(12) Patent Application Publication
(10) Pub. No.: US 2025/0203335 A1
(43) Pub. Date: Jun. 19, 2025

(54) Enhancements for Minimization of Service Interruption

(71) Applicant: Apple Inc., CUPERTINO, CA (US)

(72) Inventors: Anikethan Ramakrishna VIJAYA KUMAR, Mysuru (IN); Basant KUMAR, Bangalore (IN); Nirlesh KOSHTA, Bangalore (IN); Shashanka Totadamane RAMAPPA, Shivamogga (IN); Sridhar PRAKASAM, Fremont, CA (US); Sudeep Manithara VAMANAN, Uttenreuth (DE); Vivek G GUPTA, San Jose, CA (US)

(21) Appl. No.: 18/849,695

(22) PCT Filed: Mar. 22, 2023
(86) PCT No.: PCT/US2023/015925

§ 371 Date: Sep. 23, 2024

(30) Foreign Application Priority Data
Mar. 30, 2022 (IN) 202241018883

(51) Int. Cl. H04W 4/90; H04W 48/04; H04W 48/18; H04W 60/04; H04W 84/04

(52) U.S. Cl. CPC H04W 4/90; H04W 48/04; H04W 48/18; H04W 60/04; H04W 84/042

(57) ABSTRACT

A user equipment (UE) is configured to identify a disaster condition applies to a first public land mobile network (PLMN), select a second PLMN for disaster roaming services, wherein one or more tracking areas (TAs) of the second PLMN are in a forbidden list stored locally at the UE and wherein the second PLMN and the first PLMN have a roaming agreement for disaster roaming services and register with the second PLMN for disaster roaming services in the one or more TAs of the second PLMN from the forbidden list.

### BACKGROUND

A user equipment (UE) may connect to a network that supports minimization of service interruption (MINT). MINT provides a framework that enables the UE of a given public land mobile network (PLMN) to obtain disaster roaming services from another PLMN during a disaster condition. This provides UEs with an opportunity to mitigate service interruptions and failures in the event of a disaster.

### SUMMARY

Some exemplary embodiments are related to a method performed by a user equipment (UE). The method includes selecting a first public land mobile network (PLMN) for disaster roaming services and initiating a disaster roaming wait timer, wherein the UE does not initiate a normal registration with the first PLMN when the disaster roaming wait timer is running.

Other exemplary embodiments are related to a method performed by a user equipment (UE). The method includes identifying a disaster condition applies to a first public land mobile network (PLMN), selecting a second PLMN for disaster roaming services, wherein one or more tracking areas (TAs) of the second PLMN are in a forbidden list stored locally at the UE and wherein the second PLMN and the first PLMN have a roaming agreement for disaster roaming services and registering with the second PLMN for disaster roaming services in the one or more TAs of the second PLMN from the forbidden list.

Still further exemplary embodiments are related to a method performed by a user equipment (UE). The method includes selecting a public land mobile network (PLMN) for registration under disaster conditions, wherein the selecting is performed manually at the UE, initiating a registration procedure with the PLMN, wherein the PLMN is in a forbidden PLMN list, receiving a type of reject cause for the registration procedure, wherein the registration procedure is for normal services and autonomously initiating a registration procedure for disaster roaming services based on the type of reject cause.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for access to and recovery from disaster roaming services according to various exemplary embodiments.

### DETAILED DESCRIPTION

The exemplary embodiments may be further understood with reference to the following description and the related appended drawings, wherein like elements are provided with the same reference numerals. The exemplary embodiments relate to minimization of service interruption (MINT). As will be described in more detail below, the exemplary embodiments introduce enhancements for access to and recovery from disaster roaming services.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) network that supports MINT. Generally, MINT refers to a framework that enables UEs to obtain disaster roaming services from a public land mobile network (PLMN) during a disaster condition. For instance, a PLMN may be unable to provide service in the event of a disaster, e.g., natural disasters, fires, explosions, transportation accidents, etc. MINT may enable UEs of a given PLMN to obtain connectivity service (e.g., voice call, mobile data service, etc.) from another PLMN when the disaster condition applies. Thus, UEs may have the opportunity to mitigate service interruptions and failures in the event of a disaster. Throughout this description, a UE that cannot get service from a PLMN that it would normally be served by due to failure of service during a disaster condition and that is able to register with other PLMNs may be referred to as a “disaster inbound roamer.”

A disaster condition may be initiated and terminated by a government or any other appropriate entity. The disaster condition may be applicable to a particular geographical region for a particular duration of time. Throughout this description, the disaster condition may be characterized as applying to a UE, a particular geographical region and/or PLMN. To differentiate between different types of PLMNs, reference is made to a PLMN with disaster condition and a PLMN without disaster condition. The term “PLMN with disaster condition” identifies a PLMN to which a disaster condition applies and the term “PLMN without disaster condition” identifies a PLMN that is not subject to a disaster condition. The PLMN without disaster condition may offer disaster roaming services to UEs of a PLMN with disaster condition, e.g., disaster inbound roamers. However, a PLMN without disaster condition is not required to offer disaster roaming services.

As indicated above, when the disaster condition applies, UEs may have the opportunity to mitigate service interruptions and failures. To provide an example, the UE may have no coverage of its home PLMN (HPLMN) and obtain information that a disaster conditions applies to the HPLMN. The UE may then register with another PLMN offering disaster roaming services within the region where the disaster condition applies. When the disaster condition ends and is no longer applicable to the HPLMN, the currently camped PLMN may stop offering disaster roaming services. The UE may then perform network reselection/reregistration to return to its HPLMN. This example is merely provided for illustrative purposes. The exemplary embodiments do not require a HPLMN to be subject to a disaster condition and may be used with any appropriate type of PLMN with disaster condition.

Disaster roaming generally refers to a third generation partnership program (3GPP) roaming policy that applies during a disaster condition. MINT provides a framework to facilitate disaster roaming which may include operations on the UE side and/or network side that may not be permitted when a disaster condition is not present. To provide an example, in accordance with some aspects of disaster roaming, the UE attempt to access PLMNs in a forbidden PLMN list during a disaster condition. In this description, MINT and its related terms such as, but not limited to, “disaster condition,” “disaster roaming,” “PLMN with disaster condition,” “PLMN without disaster condition” and “disaster inbound roamer” are used in the manner in which they are defined in various 3GPP specification and may be modified in accordance with the exemplary embodiments described herein.

In one aspect, the exemplary embodiments relate to accessing and maintaining disaster roaming services during a disaster condition. As will be described in more detail below, the exemplary embodiments introduce enhancements for obtaining disaster roaming services on forbidden tracking areas (TAs), handling MINT not being supported by lower order radio access technologies (RATs), handling abnormal reject causes for disaster roaming, manual PLMN selection on a PLMN offering disaster roaming services, handling backoff timers during a disaster condition, handling an emergency session when registered for disaster roaming and selecting a mobility substate when one of disaster roaming or disaster return wait timers are running.

In another aspect, the exemplary embodiments relate to recovery from disaster roaming services when the disaster condition ends. As will be described in more detail below, the exemplary embodiments introduce enhancements for reducing signaling load on an allowed PLMN when the UE returns from disaster condition, enabling quick registration onto allowed PLMN when the UE returns from a PLMN offering disaster roaming service and handling a change in broadcast information indicating alleviation of disaster condition when the UE 110 has an active session.

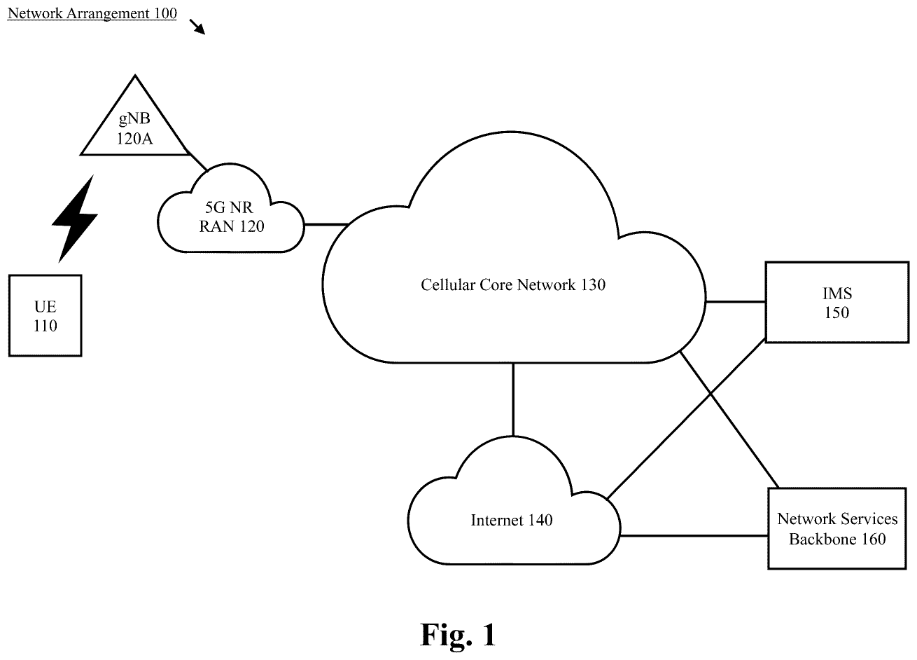

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

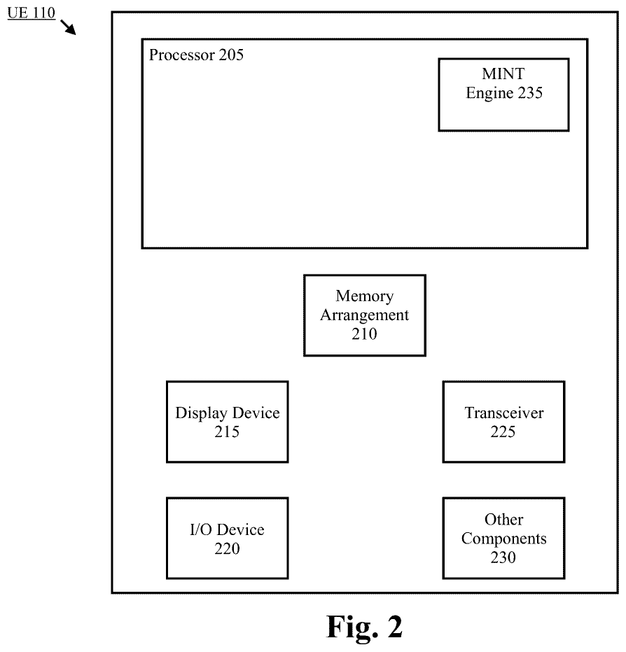

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a MINT engine 235. The MINT engine may perform various operations related to MINT such as, but not limited to, identifying a disaster condition and attempting to register with a PLMN for disaster roaming services.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

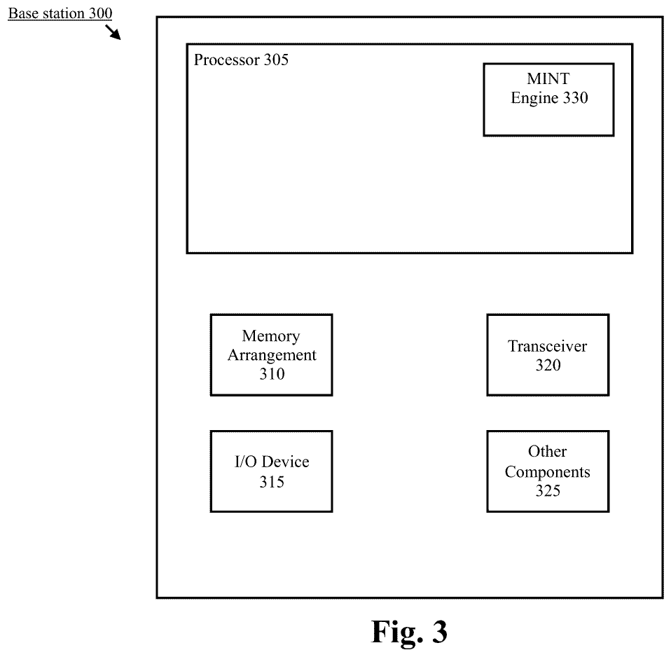

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices, etc.

The processor 305 may be configured to execute a plurality of engines for the base station 300. For example, the engines may include a MINT engine 330. The MINT engine 330 may perform various operations related to MINT. These operations may include, but are not limited to, transmitting an indication of a disaster condition, performing registration with a UE for disaster roaming services and transmitting an indication that a disaster condition has ended.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

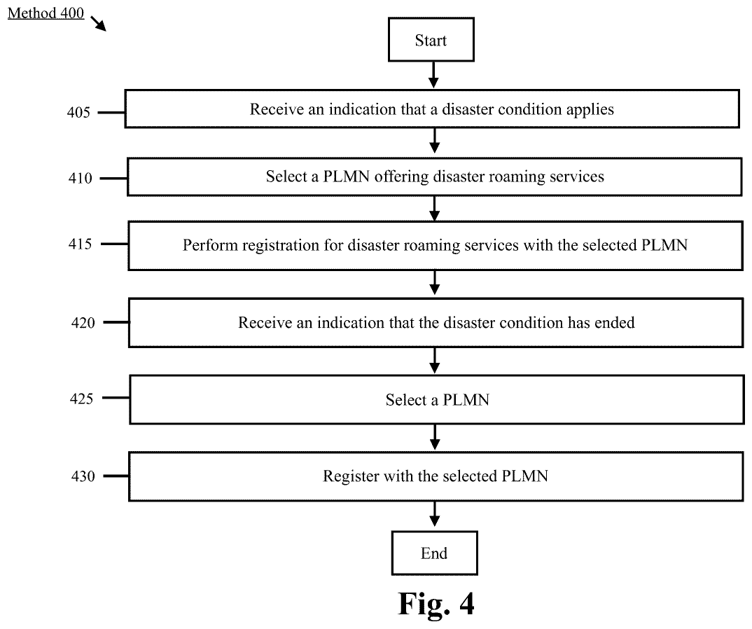

FIG. 4 shows a method 400 for access to and recovery from disaster roaming services according to various exemplary embodiments. The method 400 will be described with regard to the network arrangement 100 of FIG. 1 and the UE 110 of FIG. 2.

The method 400 describes a scenario where the UE 110 accesses disaster roaming services during a disaster condition and recovers from disaster roaming when the disaster condition ends. The method 400 is described from the perspective of the UE 110. However, the method 400 includes enhancements on the UE 110 side and the network side.

The example scenario described below is provided to demonstrate how the various exemplary enhancements introduced herein may be utilized for MINT. However, the exemplary enhancements are not limited to this example. These exemplary enhancements may be used independently from one another, in conjunction with other currently implemented MINT mechanisms, future implementations of MINT mechanisms or independently from other MINT mechanisms.

In 405, the UE 110 receives an indication that a disaster condition applies to one or more PLMNs. As mentioned above, a government or any other appropriate entity may initiate a disaster condition. Once initiated, base stations of PLMNs with disaster condition and/or the base stations of PLMNs without disaster condition may broadcast information indicating that a disaster condition applies to one or more PLMNs. The disaster condition may apply to the HPLMN of the UE 110 or any other type of PLMN the UE 110 is permitted to access. The disaster condition information may be included in a system information block (SIB) or any other appropriate type of message.

From the perspective of the UE 110, the disaster condition information may indicate that a particular PLMN may be unable to provide service to the UE 110 within the region where the disaster condition applies and a PLMN offering disaster roaming services may be able to provide service to the UE 110 within the region where the disaster condition applies. The UE 110 may then search for a PLMN to receive service. However, the reception of the disaster condition information is not required to trigger the UE 110 search for a PLMN offering disaster roaming services.

In 410, the UE 110 selects a PLMN offering disaster roaming services. The UE 110 may then attempt to register with the selected PLMN to receive service. For example, the UE 110 may have no service or limited service. The UE 110 may then be triggered to search for a PLMN. Thus, the UE 110 may tune its transceiver 225 to various different frequencies searching for information broadcast by base stations of PLMNs. The UE 110 may receive the indication of the disaster condition (e.g., 405) during this search or may receive the indication of the disaster condition prior to this PLMN search. As will be described in more detail below, the UE 110 may receive various different types of information from the one or more PLMNs that may be used to select a PLMN for camping. In this example, the selected PLMN offers disaster roaming services, however, the UE 110 is not required to select a PLMN offering disaster roaming services.

Prior to the occurrence of the disaster condition, the UE 110 may be provisioned by the network with information that may be used during disaster roaming. For example, the HPLMN of the UE 110 may provide an indication as to whether disaster roaming is enabled in the UE 110, the HPLMN and/or VPLMN may provide a list of PLMNs to be used in a disaster condition comprising zero or more PLMN IDs, the HPLMN and/or VPLMN may provide a disaster roaming wait range consisting of a minimum wait time and a maximum wait time and the HPLMN and/or VPLMN may provide a disaster return wait range consisting of a minimum wait time and a maximum wait time. In addition, the UE 110 may be preconfigured with some or all of the above referenced information.

During the search for the PLMN selected in 410, the UE 110 may also receive an indication from a PLMN indicating whether disaster roamers are permitted to access the PLMN. This indication may be broadcast in a SIB or any other appropriate type of message.

In some examples, when the disaster condition applies, the UE 110 may select a PLMN that is stored in a forbidden PLMN list. Those skilled in the art will understand that the forbidden PLMN list is stored locally at the UE 110 (e.g., SIM, memory arrangement 210, combination thereof, etc.) and includes zero or more PLMN IDs. Typically, the UE 110 does not attempt to register with a PLMN of the forbidden PLMN list. However, disaster roaming enables the UE 110 to access PLMNs in a forbidden PLMN list if a disaster condition applies.

In some regions, PLMNs may have localized roaming agreements. In this arrangement, instead of rejecting subscribers from other PLMNs using a reject cause indicating a PLMN is not allowed (e.g., cause #11), more localized reject causes indicating a subscriber is not allowed in the TA may be utilized. For example, reject cause indicating a TA is not allowed (e.g., cause #12), roaming is not allowed in this TA (e.g., cause #13) and no suitable cells in this TA (e.g., cause #15) may be utilized to reject subscribers. If the UE 110 receives one of these types of reject causes, the UE 110 may enter the corresponding TA into a forbidden TA list stored locally at the UE 110 (e.g., SIM, memory arrangement 210, combination thereof, etc.) to avoid subsequent registration attempts on those TAs. The UE 110 may have a single forbidden TA list for all TAs associated with a reject cause related to TAs (e.g., reject cause #12, 13, 15, etc.), a different forbidden TA list for each reject cause related to TAs (e.g., reject cause #12, 13, 15, etc.) or any other appropriate type of arrangement of one or more forbidden TA lists (e.g., “5GS forbidden tracking areas for roaming,” “forbidden tracking areas for regional provision of service” or any other forbidden list corresponding to a reject cause related to TAs). When a more localized reject cause is utilized, the corresponding PLMN may not be stored in the forbidden PLMN list but one or more TAs of that PLMN may be stored in a forbidden TA list. Under conventional circumstances, when a disaster condition applies, the UE 110 may not consider cells of a PLMN with TAs in the forbidden TA list when registering for disaster roaming services even when the corresponding PLMN is offering disaster roaming services because the UE 110 may be configured to only consider the forbidden PLMN list when selecting a PLMN during a disaster condition.

The exemplary embodiments introduce enhancements that allow the UE 110 to consider the forbidden TA list when selecting a PLMN. In some embodiments, when no suitable cell is available for normal registration, the UE 110 may choose acceptable cells of a PLMN that is not in the forbidden PLMN list but has TAs in a forbidden TA list. Thus, the UE 110 may select a PLMN with a TA stored in a forbidden TA list when selecting a PLMN for disaster roaming services. In addition, the UE 110 may disregard and/or delete TAs in a forbidden TA list and/or forbidden TAs for roaming list associated with the PLMN on which disaster roaming registration is being initiated.

In 415, the UE 110 performs registration for disaster roaming services with the selected PLMN. For example, the UE 110 may send a registration request message to the network indicating an initial registration for disaster roaming services. In another example, the UE 110 may send a registration request message to the network indicating a mobility registration for disaster roaming services. Once successfully completed, the UE 110 may be considered as registered for disaster roaming services.

In this example, the registration for disaster roaming services is successful. However, there may be scenarios where the registration for disaster roaming services is unsuccessful. According to some aspects, the exemplary embodiments introduce enhancements for handling abnormal reject causes for disaster roaming. When the UE 110 attempts disaster registration on a PLMN and the UE 110 receives a reject cause which results in the UE 110 being triggered to add the PLMN or the TA of the PLMN to one of the forbidden lists, the UE 110 may attempt to determine whether or not the PLMN is offering disaster roaming services. For example, the UE 110 may search for the system information indicating a disaster condition. If the UE 110 identifies one or more conditions indicating that the PLMN offers disaster roaming services after receiving a reject cause from the PLMN when attempting to register for disaster roaming services, the UE 110 may consider this an abnormal case and handle the reject cause as an abnormal reject cause. The UE 110 may then perform operations associated with receiving an abnormal reject cause such as, but not limited to, increasing the registration attempt counter, setting the 5GS update (5U) status as 5U2 not updated, moving to the relevant substrate related to abnormal cases and starting timer T3511. Upon expiration of timer T3511, the UE 110 may re-attempt registration on the PLMN.

In another embodiments, the UE 110 may bar the cell after receiving a PLAIN reject message with a reject cause that triggers the UE 110 to add the TA and/or the PLMN to one of the forbidden PLMN or TA lists. Those skilled in the art will understand that a PLAIN message may refer to a message that is received without security protection (e.g., non-integrity protected). Thus, to handle a reject cause when attempting to register for disaster roaming services, the UE 110 may bar the cell from being considered by the UE 110 for disaster roaming services. However, the UE 110 may still consider other cells of the same TA or PLMN which may offer disaster roaming services. In another embodiment, to handle a reject cause when attempting to register for disaster roaming services, the UE 110 may add the PLMN and/or the TA to the corresponding forbidden list and may also mark the PLMN and/or the TA as not being available for disaster roaming services. The UE 110 may subsequently not select the PLMN and/or the TA for disaster roaming registration attempts until a predetermined event occurs. The predetermined event may include, but is not limited to, a power off, SIM removal, the end of a disaster condition, periodically based on a list validity timer or until the UE 110 moves back to the allowed PLMN. After the predetermined event, the UE 110 may remove the entries from the forbidden lists which have been marked as being added due to receiving a reject message when attempting disaster roaming services.

As mentioned above, the UE 110 may be provisioned with a disaster roaming wait range consisting of a minimum wait time and a maximum wait time. In some examples, the UE 110 may generate a random number within the disaster roaming wait range and start a timer with the generated random number. While the timer is running, the UE 110 may not initiate registration on the selected PLMN. Upon expiration of the timer, the UE 110 may perform a registration procedure with a 5G system (5GS) registration type value set to disaster roaming registration. This may be done to mitigate congestion or strain on the PLMN accepting disaster inbound roamers.

According to some aspects, the exemplary embodiments introduce enhancements for manual PLMN selection on a PLMN offering disaster roaming services. A user may manually initiate a search and select a PLMN to request access for service. When a PLMN is selected for manual registration and conditions related to disaster registration are satisfied, the UE 110 may attempt disaster registration on the manually selected PLMN. This provides flexibility to the network to evaluate the UE 110 as both a normal inbound roamer and a disaster inbound roamer. If the UE 110 attempting disaster roaming registration is allowed to access services of the PLMN as a normal inbound roamer, the network may indicate to the UE 110 that the network has accepted the registration as a normal registration and not as disaster registration. If the UE 110 attempts normal registration on a manually selected PLMN and receives a registration reject message with cause #11, 12, 14 or 15 and the if the cell of the selected PLMN passes the criteria for a disaster roaming registration attempt, the UE 110 may autonomously attempt disaster registration on the selected PLMN without user intervention. There may also be a scenario where the UE 110 attempts normal registration assuming that the PLMN is an allowed PLMN. However, on the network side, the UE 110 subscription information indicates that the UE 110 does not have access to normal services on the selected PLMN but has access to disaster roaming services on the selected PLMN during the disaster condition. In this type of scenario, the network may indicate in the registration accept that the registration of the UE 110 has been accepted not as a normal registration but as disaster registration and the network may additional indicate the PLMN for which disaster roaming is being offered.

In addition, the exemplary embodiments introduce enhancements for handling a T3346 timer during a disaster condition. When the UE 110 is registered or attempting registration for disaster roaming services and receives a reject cause #22 for congestion, the UE 110 may start of backoff timer T3346. This backoff timer restricts PLMN selection on the UE 110 side and the UE 110 may be expected to stay camped on the same PLMN and move to a different PLMN only based on reselection or loss of coverage. However, this behavior may not be beneficial for disaster roaming. The exemplary embodiments introduce an enhancement where if the T3346 is running when the UE 110 is registered or attempted registration for disaster roaming and if later the UE 110 determines that disaster roaming is no longer applicable based on a change in broadcast information in the 5G NG RAN, the UE 110 may stop the T3346 and take actions related to alleviation of disaster roaming by attempting to search for and select the PLMN which was previously under disaster condition. In addition, when the T3346 is running, the UE 110 may choose to periodically attempt to search for availability of allowed PLMNs without disaster condition and may choose to attempt registration on the PLMNs found during the search.

The exemplary embodiments introduce enhancements for handling emergency services when registered for disaster roaming. When the UE 110 is registered for disaster roaming services, the availability of other RATs may be restricted. However, to establish and/or maintain an emergency protocol data unit (PDU) session, the UE 110 may need to be able to access other RATs to provide continuity of emergency session. The exemplary embodiments introduce enhancements such that when registered for disaster roaming services, if an emergency PDU session is established, lower layers such as, the access stratum components in the UE 110 may be notified that reselection to all RATs in the selected PLMN are allowed. This notification to the lower layers of the UE 110 may be explicit where the upper layers of the UE 110 indicate that the reselection restrictions have been cleared or may be implicitly derived by access strata based on existing indication of emergency sessions being active. Additionally, to ensure that the UE 110 gets access to normal services on 5GS, the UE 110 may prioritize staying on and reselecting to 5GS cells that support disaster roaming. When no such cells are available, the UE 110 may consider reselection to EUTRAN (or any other RAT) on the selected PLMN.

In 420, the UE 110 receives an indication that the disaster condition has ended. As mentioned above, a government or any other appropriate entity may terminate a disaster condition. Once terminated, a base station of the PLMN providing disaster roaming services to the UE 110 may indicate that the disaster condition no longer applies and disaster roaming services are no longer available via the currently camped PLMN. This indication may be provided via de-registration, SIB, a lack of system information indicating a disaster condition or any other appropriate type of indication.

In 425, the UE 110 selects a PLMN. The UE 110 may select the PLMN that was previously under disaster condition, however, the UE 110 is not required to select this PLMN. In 430, the UE 110 registers with the selected PLMN. For example, the UE 110 may initiate a registration procedure to receive network services when the disaster condition has ended. Thus, the UE 110 may tune its transceiver to various frequencies searching for a PLMN. The selected PLMN may be the same PLMN that had previously experienced the disaster condition or any other appropriate PLMN with which the UE 110 is permitted to access.

The exemplary embodiments introduce enhancements for handling a change in broadcast information indicating alleviation of disaster condition when the UE 110 has an active session. For example, a scenario may occur where the UE 110 is in an active session when the disaster condition ends. Under conventional circumstances, the UE 110 may abruptly drop the ongoing session which may cause a bad use experience.

In some embodiments, if the UE 110 has an active session with a persistent bearer and if a change in cell broadcast information indicating that the disaster condition has ended is identified, the UE 110 may wait until the session is released and the persistent bearer is deactivated before returning to the PLMN that was previously under disaster condition or any other allowed PLMN.

The duration for which the session with the persistent bearer is allowed to continue may be equal to the disaster return wait time maximum value. When the UE 110 detects a change in disaster roaming condition during an active non-emergency persistent bearer session, the UE 110 may start a timer with a value equal to the maximum value of the disaster return wait range. If the session ends before the expiry of the timer, the UE 110 may initiate a PLMN search and attempt to camp and register on a PLMN which was previously under disaster condition. If the timer expires and the non-emergency persistent bearer session has not ended, the UE 110 may abort the ongoing session and attempt to search and select the PLMN which was previously under disaster condition. On the network side, the PLMN offering disaster roaming may also allow the persistent bearer session to continue after the alleviation of the disaster condition for the duration of the maximum value of the disaster return wait range.

After the disaster condition has ended, a large number of UEs may be expected to return to the PLMN previously under disaster condition. This may cause the PLMN previously under disaster condition to experience a high signaling load which may have a negative impact on the network performance. In one approach, the UE 110 may be provisioned with a disaster return wait range consisting of a minimum wait time and a maximum wait time. In some examples, the UE 110 may generate a random number within the disaster return wait range and start a timer with the generated random number. While the timer is running, the UE 110 may not initiate registration on the selected PLMN. Upon expiration of the timer, the UE 110 may perform a registration procedure with the selected PLMN. Thus, UEs may stagger the registration signaling on the PLMN which was previously under disaster condition. This may be to mitigate congestion or strain on the PLMN that may be caused by the UEs returning to the PLMN after the disaster condition ends.

It has been identified that in cases where the UE 110 returns back to the PLMN which was previously under disaster condition, the UE 110 may initiate a mobility registration updated procedure. However, the PLMN is unlikely to able to retrieve the UE 110 context from the PLMN that previously providing disaster roaming services. The network may provide a reject cause to this registration attempt. The UE 110 may then attempt to register with the PLMN via initial registration with subscription concealed identifier (SUCI). In other scenarios, the PLMN may initiate an identification procedure for the SUCI of the UE 110 and then proceed with registration. Thus, the use of the mobility registration update procedure has been identified to cause an unnecessary signaling load when the UEs return to an allowed PLMN from a disaster condition.

The exemplary embodiments introduce a technique where a UE 110 returning to a PLMN previously under disaster condition, after being registered for disaster roaming services with another PLMN, initiates initial registration with SUCI. Those skilled in the art will understand that the SUCI is a privacy preserving identifier containing a concealed subscription permanent identifier (SUPI). Thus, the SUCI may be generated based on the SUPI and a public key that was provisioned by the HPLMN. Utilizing initial registration with SUCI may reduce the signaling load because it may allow the signaling that may be caused as a result of a failed mobility registration update procedure to be avoided and the signaling related to the identification procedure for the SUCI to be avoided.

There may be scenarios where the UE 110 moves to an allowed PLMN from a PLLMN offering disaster roaming service via triggers on the UE 110 side. This is in contrast to the network moving UEs away from a PLMN offering disaster roaming services when a disaster condition ends (e.g., triggering de-registration, indicating that disaster condition has ended, etc.). To provide some examples of the UE 110 side triggers, the UE 110 may find an allowed PLMN during a PLMN search triggered as part of a PLMN search timer expiry or finding the allowed PLMN when attempting service recovery after losing coverage of the PLMN offering disaster roaming services. When a trigger on the UE 110 side causes the UE 110 to return to an allowed PLMN from a PLMN offering disaster roaming services, no signaling overload is expected. Thus, the UE 110 may skip utilizing the disaster return wait timer. Instead, the UE 110 may attempt normal registration of the allowed PLMN at any point after the PLMN is found during the PLMN search that may occur after the UE 110 side trigger condition occurs. However, the exemplary embodiments are not limited to the example trigger conditions mentioned above, if the UE 110 returns to an allowed PLMN from a PLMN offering disaster roaming services and if the return was not due to network initiated deregistration or if the return was not due to removal of broadcast information related to disaster roaming, then the UE 110 shall not start the disaster return wait timer and may immediately attempt registration on the allowed PLMN. This may ensure a faster recovery of service for the UE 110 in these types of scenarios.

The exemplary embodiments introduce enhancements related to which 5GMM substate is to be chosen when one of disaster roaming or disaster return wait timers are running. When either one of these timers are running, the UE 110 may not be expected to attempt any registration on the selected PLMN. In this scenario, it would be beneficial for the UE 110 to choose the right 5GMM substate that reflects the proper UE 110 status and seamlessly allow/disallow activity on the UE 110 side. In one example, the UE 110 may choose the substate “5GMM-DEREGISTERED.ATTEMPTING-REGISTRATION” or “5GMM-REGISTERED.ATTEMPTING-REGISTRATION-UPDATE” depending on whether the UE 110 is in a DEREGISTERED or REGISTERED state and if either of the disaster roaming wait timer of the disaster return wait timer is active. If there is a request from upper layers to establish an emergency session or to initiate IMS multimedia telephony service (MMTel), the UE 110 may stop the disaster roaming or disaster return wait timers and immediately attempt registration on the camped PLMN.

According to some aspects, the exemplary embodiments introduce enhancements for handling of MINT not being supported by lower RATs. MINT is supported in 5GS and is not supported in evolved packet system (EPS)/evolved-UMTS terrestrial radio access network (EUTRAN), e.g., LTE. MINT signaling between certain network nodes may provide EUTRAN as a restricted RAT to ensure that the UE 110 is not redirected or handed over to EUTRAN by the network when registering for disaster roaming in 5GS. However, it has been identified that a scenario may occur where a UE registered for disaster condition attempts to reselect to EUTRAN of the same PLMN to receive certain services. The exemplary embodiments introduce enhancements to avoid these types of scenario.

In some embodiments, a UE 110 registering or registered for disaster roaming service in 5GS may disable EUTRA capability and indicate the same to the network. This may ensure that neither the network nor the UE 110 attempts to move from a 5G RAT to LTE RAT while camped on a PLMN providing disaster roaming services. In another embodiment, a UE 110 attempting registration or already registered for disaster roaming service may consider EUTRAN as a RAT that is not available for normal service on the PLMN offering disaster roaming services. Thus, when on the PLMN offering disaster roaming services, the UE 110 may ignore triggers that would cause the UE 110 to select EUTRAN. To provide an example, the UE 110 may be triggered to select EUTRAN of a registered PLMN when voice service is unavailable in 5G NR. The UE 110 may ignore this trigger when on the PLMN offering disaster roaming services and remain connected to the 5G NR RAN of the PLMN offering disaster roaming services. In another example, under conventional circumstances, the UE 110 may reach a maximum number of registration attempt failures due to connectivity issues. The UE 110 may then disable 5G NR on the selected PLMN and try to find service on a different RAT of the same PLMN. According to some exemplary embodiments, if the UE 110 reaches a maximum number of registration attempt failures on a 5G NR PLMN when attempting registration for disaster roaming services, the UE 110 may ignore or omit operations related to searching for service on EUTRAN or any other RAT of the same PLMN.

In some embodiments, a UE 110 registered for disaster roaming services may indicate to lower layers such as a NR radio resource control (NRRRC) component that EUTRAN is a restricted RAT and that the UE 110 is not expected to reselect to that RAT when registered for disaster roaming service.

In other embodiments, a UE 110 registered for disaster roaming may indicate to lower layers that the current registration is for disaster roaming and that lower layers can reselect to cells of the current PLMN (or equivalent PLMN (EPLMN)) only if they too broadcast the indications related to disaster roaming and if the same PLMN which the UE 110 has considered as being under disaster condition is part of the broadcast information or if the UE 110 is able to implicitly infer based on the broadcast information that the cell supports disaster inbound roaming for the PLMN that the UE 110 has deemed is under disaster. For example, consider a scenario where PLMN-1 is under disaster condition and PLMN-2 is offering disaster roaming service to subscribers of PLMN-1. The UE 110 then gets accepted by PLMN-2 as a disaster inbound roamer of PLMN-2. The UE 110 may then move to idle mode. In idle mode, the UE 110 identified multiple cells of PLMN-2. Some of the cells may broadcast indications related to disaster and some of them do not. This may be a means for the network to keep the disaster inbound roamer within only certain cells. In this type of scenario, even though all the multiple cells belong to PLMN-2, the UE 110 may only reselect to a subset of the multiple cells that are part of PLMN-2 and that broadcast disaster information.

### Examples

In a first example, a processor of a user equipment (UE) is configured to perform operations comprising identifying a disaster condition applies to a first public land mobile network (PLMN), selecting a second PLMN for disaster roaming services, wherein one or more tracking areas (TAs) of the second PLMN are in a forbidden list stored locally at the UE and wherein the second PLMN and the first PLMN have a roaming agreement for disaster roaming services and registering with the second PLMN for disaster roaming services in the one or more TAs of the second PLMN from the forbidden list.

In a second example, the processor of the first example, wherein the forbidden list is one of a forbidden TA list, a forbidden TA for roaming list or a forbidden TA for regional provision of service list.

In a third example, the processor of the second example, wherein the second PLMN is not in a forbidden PLMN list stored locally at the UE.

In a fourth example, the processor of the first example, the operations further comprising removing the one or more TAs of the second PLMN from the forbidden list in response to registering with the second PLMN for disaster roaming services.

In a fifth example, the processor of the first example, the operations further comprising receiving an indication that the second PLMN is offering disaster roaming services, wherein the UE is configured to consider a TA of the second PLMN that is part the forbidden list as being available for disaster roaming services in response to the indication.

In a sixth example, a processor of a user equipment (UE) is configured to perform operations comprising registering with a first public land mobile network (PLMN) for disaster roaming services, identifying the disaster condition no longer applies to a second PLMN and initiating an initial registration procedure with the second PLMN using a subscription concealed identifier (SUCI) in response to identifying that the disaster condition no longer applies to the second PLMN.

In a seventh example, a processor of a user equipment (UE) is configured to perform operations comprising receiving a disaster return wait timer range comprising a minimum wait time and a maximum wait time, registering with a first public land mobile network (PLMN) for disaster roaming services, selecting a second PLMN for normal registration, registering with the second PLMN, wherein the UE does not utilize a disaster wait timer prior to registering with the second PLMN based on a type of trigger condition that initiated a search for the second PLMN.

In an eighth example, the processor of the seventh example, wherein the trigger condition that initiated the search for the second PLMN is one of a PLMN search timer expiry or losing coverage of the first PLMN providing disaster roaming services.

In a ninth example, a processor of a user equipment (UE) is configured to perform operations comprising registering with a first public land mobile network (PLMN) for disaster roaming services, wherein the disaster roaming services are provided by a fifth generation (5G) radio access technology (RAT) of the first PLMN connected to a fifth generation core (5GC) and determining that an long term evolution (LTE) RAT connected to a evolved packet core (EPC) is not available on the first PLMN providing disaster roaming services.

In a tenth example, the processor of the ninth example, the operations further comprising disabling LTE capability at the UE when registered with the first PLMN for disaster roaming services of a fifth generation system (5GS).

In an eleventh example, the processor of the ninth example, the operations further comprising receiving an indication that a trigger condition for the UE to select the LTE RAT connected to the EPC has occurred and ignoring the trigger condition, wherein ignoring the trigger condition comprises declaring a failure of the selection of the LTE RAT connected to the EPC.

In a twelfth example, the processor of the ninth example, the operations further comprising indicating to lower layers that the LTE RAT is a restricted RAT and the UE is not to reselect the LTE RAT when registered for disaster roaming services of a fifth generation system (5GS).

In a thirteenth example, a processor of a user equipment (UE) is configured to perform operations comprising identifying a disaster condition applies to a first public land mobile network (PLMN) and transmitting a registration request to a second PLMN for disaster roaming services, wherein the second PLMN is a non-allowed PLMN and receiving a registration reject cause from the second PLMN.

In a fourteenth example, the processor of the thirteenth example, the operations further comprising determining, after receiving the reject cause, that the second PLMN is offering disaster roaming services, initiating a timer in response to the reject cause and attempting reregistration on the second PLMN when the timer expires.

In a fifteenth example, the processor of the fourteenth example, wherein the timer is a T3511 timer.

In a sixteenth example, the processor of the fourteenth example, the operations further comprising increasing a registration attempt counter in response to the reject cause, updating a fifth generation system (5GS) update (5U) statue in response to the reject cause and updating a mobility substate of the UE in response the reject cause.

In a seventeenth example, the processor of the thirteenth example, the operations further comprising adding one of a tracking area (TA) of the second PLMN or the second PLMN to a forbidden list and barring a cell that transmitted the registration reject cause to the UE.

In an eighteenth example, the processor of the thirteenth example, the operations further comprising adding one of a tracking area (TA) of the second PLMN or the second PLMN to a forbidden list and storing an indication that the one of the TA of the second PLMN or the second PLMN is not available for disaster roaming.

In a nineteenth example, a processor of a user equipment (UE) is configured to perform operations comprising selecting a public land mobile network (PLMN) for registration under disaster conditions, wherein the selecting is performed manually at the UE and initiating a registration procedure with the PLMN, wherein the PLMN is in a forbidden PLMN list.

In an twentieth example, the processor of the nineteenth example, wherein the registration procedure is for disaster roaming services.

In an twenty first example, the processor of the nineteenth example, the operations further comprising receiving a type of reject cause for the registration procedure, wherein the registration procedure is for normal services and autonomously initiating a registration procedure for disaster roaming services based on the type of reject cause.

In an twenty second example, the processor of the twenty first example, wherein the type of reject cause is one of reject cause #11, reject cause #12, reject cause #13 or reject cause #15.

In a twenty third example, a processor of a user equipment (UE) configured to perform operations comprising initiating registration with a first public land mobile network (PLMN) for disaster roaming services, receiving a reject cause indicating congestion, initiating a backoff timer in response to the reject cause, identifying, when the backoff timer is running, that a disaster condition no longer applies to a second PLMN based on a change to broadcast information and initiating registration with the second PLMN prior to the expiration of the backoff timer.

In an twenty fourth example, the processor of the twenty third example, wherein the backoff timer is a T3346 timer.

In an twenty fifth example, the processor of the twenty third example, wherein the UE is configured to periodically search for allowable PLMNs not under disaster condition when the backoff timer is running.

In a twenty sixth example, a processor of a user equipment (UE) is configured to perform operations comprising registering with a public land mobile network (PLMN) for disaster roaming services, establishing an emergency protocol data unit session (PDU) session and indicating to lower layers of the UE that reselection to all radio access technologies (RATs) in the PLMN is permitted.

In a twenty seventh example, a processor of a user equipment (UE) is configured to perform operations comprising identifying a disaster condition applies to a first public land mobile network (PLMN), registering with a second PLMN for disaster roaming services, establishing a session with a persistent bearer via a cell of the second PLMN and identifying, while the session with the persistent bearer is active, the disaster condition no longer applies to the first PLMN based on a change in broadcast information.

In an twenty eighth example, the processor of the twenty seventh example, wherein the UE waits until the session is released and the persistent bearer is deactivated to attempt to return to the first PLMN in response to identifying the disaster condition no longer applies to the first PLMN.

In an twenty ninth example, the processor of the twenty seventh example, the operations further comprising initiating a timer in response to identifying the disaster condition no longer applies to the first PLMN, wherein the timer is set to a value equal to a maximum return wait time, when the session ends prior to the expiration of the timer, the UE initiates registration with the first PLMN and when the timer expires prior while the session is active, the UE terminates the session and initiates registration with the first PLMN.

In a thirtieth example, a processor of a user equipment (UE) configured to perform operations comprising selecting a public land mobile network (PLMN) for disaster roaming services, initiating a disaster roaming wait timer and selecting, when the disaster roaming wait timer is running and the UE is deregistered, a fifth generation mobility management (5GMM) substate of 5GMM-DEREGISTERED.ATTEMPTING-REGISTRATION.

In an thirty first example, the processor of the thirtieth example, the operations further comprising receiving, when the disaster roaming wait timer is running, a request to establish an emergency session or to initiate IMS multimedia telephony service (MMTel) and stopping the disaster roaming wait timer and immediately attempting registration on the PLMN in response to the request.

In a thirty second example, a processor of a user equipment (UE) is configured to perform operations comprising selecting a public land mobile network (PLMN) for registration that was previously under a disaster condition, initiating a disaster return wait timer and selecting, when the disaster return wait timer is running and the UE is registered, a fifth generation mobility management (5GMM) substate of 5GMM-REGISTERED.ATTEMPTING-REGISTRATION-UPDATE.

In an thirty third example, the processor of the thirty second example, the operations further comprising receiving, when the disaster return wait timer is running, a request to establish an emergency session or to initiate IMS multimedia telephony service (MMTel) and stopping the disaster return wait timer and immediately attempting registration on the PLMN in response to the request.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
selecting a first public land mobile network (PLMN) for disaster roaming services; and
initiating a disaster roaming wait timer, wherein the UE does not initiate a normal registration with the first PLMN when the disaster roaming wait timer is running.

2. The method of claim 1, further comprising:
receiving, when the disaster roaming wait timer is running, a request to establish an emergency protocol data unit (PDU) session with the first PLMN;
initiating an emergency registration with the first PLMN while the disaster roaming wait timer is running; and
establishing the emergency PDU session with the first PLMN when the emergency registration with the first PLMN is successful.

3. The method of claim 2, wherein the disaster roaming wait timer is stopped when the emergency registration is initiated.

4. The method of claim 2, wherein the disaster roaming wait timer continues to run when the emergency registration is initiated.

5. The method of claim 2, further comprising:
when the disaster roaming wait timer expires, initiating a regular registration with the first PLMN.

6. The method of claim 2, further comprising:
when the disaster roaming wait timer expires, waiting to initiate a regular registration with the first PLMN until the emergency PDU session is released.

7. The method of claim 1, further comprising:
selecting, when the disaster roaming wait timer is running and the UE is deregistered, a fifth generation mobility management (5GMM) substate of 5GMM-DEREGISTERED.ATTEMPTING-REGISTRATION.

8. The method of claim 1, further comprising:
selecting a second PLMN for registration that was previously under a disaster condition; and
initiating a disaster return wait timer, wherein the UE does not initiate a normal registration with the second PLMN when the disaster return wait timer is running.

9. The method of claim 8, further comprising:
receiving, when the disaster return wait timer is running, a request to establish an emergency protocol data unit (PDU) session with the second PLMN;
initiating an emergency registration with the second PLMN while the disaster roaming wait timer is running; and
establishing the emergency PDU session with the second PLMN when the emergency registration with the second PLMN is successful.

10. The method of claim 9, wherein the disaster return wait timer is stopped when the emergency registration is initiated.

11. The method of claim 9, wherein the disaster return wait timer continues to run when the emergency registration is initiated.

12. The method of claim 9, further comprising:
when the disaster return wait timer expires, initiating a regular registration with the second PLMN.

13. The method of claim 9, further comprising:
when the disaster return wait timer expires, waiting to initiate a regular registration with the second PLMN until the emergency PDU session is released.

14. The method of claim 8, further comprising:
selecting, when the disaster return wait timer is running and the UE is registered, a fifth generation mobility management (5GMM) substate of 5GMM-REGISTERED.ATTEMPTING-REGISTRATION-UPDATE.

15. A method performed by a user equipment (UE), comprising:
identifying a disaster condition applies to a first public land mobile network (PLMN);
selecting a second PLMN for disaster roaming services, wherein one or more tracking areas (TAs) of the second PLMN are in a forbidden list stored locally at the UE and wherein the second PLMN and the first PLMN have a roaming agreement for disaster roaming services; and
registering with the second PLMN for disaster roaming services in the one or more TAs of the second PLMN from the forbidden list.

16. The method of claim 15, wherein the forbidden list is one of a forbidden TA list, a forbidden TA for roaming list or a forbidden TA for regional provision of service list.

17. The method of claim 16, wherein the second PLMN is not in a forbidden PLMN list stored locally at the UE.

18. The method of claim 15, the operations further comprising:
removing the one or more TAs of the second PLMN from the forbidden list in response to registering with the second PLMN for disaster roaming services.

19. The method of claim 15, the operations further comprising:
receiving an indication that the second PLMN is offering disaster roaming services, wherein the UE is configured to consider a TA of the second PLMN that is part the forbidden list as being available for disaster roaming services in response to the indication.

20. A method performed by a user equipment (UE), comprising:
selecting a public land mobile network (PLMN) for registration under disaster conditions, wherein the selecting is performed manually at the UE;
initiating a registration procedure with the PLMN, wherein the PLMN is in a forbidden PLMN list;
receiving a type of reject cause for the registration procedure, wherein the registration procedure is for normal services; and
autonomously initiating a registration procedure for disaster roaming services based on the type of reject cause.
